(19) United States
(12) Patent Application Publication
(10) Pub. No.: US 2014/0311407 A1
(43) Pub. Date: Oct. 23, 2014

(54) Self Retaining Paint Shield for Soffits, Walls and other structures

(71) Applicant: Felipe Stacishin Queiroz, Logan, UT (US)

(72) Inventor: Felipe Stacishin Queiroz, Logan, UT (US)

(21) Appl. No.: 13/865,180

(22) Filed: Apr. 17, 2013

(51) Int. Cl. B05B 15/04

(52) U.S. Cl. CPC B05B 15/045
USPC 118/504

(57) ABSTRACT

A self retained paint shield configured to shield soffits and/or exterior walls and all applicable areas where there is an interface between areas that are to be painted and areas that are not to be painted, providing a protective surface against overspray. A semi rigid paint shield consisting of a semi rigid rectangular pad or sheet of material, such as cardboard or plastic or any other suitable material, in witch at least one of its edges along side one of its longest sides is constructed in such a way as to make it capable to be temporally attached to the desired area typically found between the adjacent surfaces such as but not limited to, the soffits and wall on the exterior of a house. The said shield can be secured in place either by the insertion of its thin edge, in between the surface to be painted and the surface not to be painted, by adhesive tape, by magnetic means or, by means of an interference fit. The paint shield being fitted with hooks, or other means of attaching a string or line, that once fitted can be used to remove the shield once the areas have been painted. The said paint shield when used in a series provides for a protective surface that permits the spraying/rollin of a wall structure without contamination of the soffit or vice-versa. The said shield, being applicable for protection of surfaces from possible contaminants such as paints, stains, stucco, stripers and all the substances that might be applicable in which the said shield use might be desired.

### BACKGROUND OF THE INVENTION

1. Field of the invention

The present invention relates to a method and apparatus for shielding paint or any other coatings and finishes such as stucco, stains and the like, from being sprayed or inadvertently applied, onto a buildings' soffits, walls or other areas (depending on the desired surface to be painted/protected) and specifically, a paint shield configured to be temporarily self-retained to the soffit/wall structure to shield the soffit or wall from overspray while painting a wall or soffit of a building or home.

2. State of the Art

When painting it is desirable that surfaces that should not receive paint, do not receive paint. When painting, stuccoing or applying any other coating on a building or home, large surfaces in general, the most efficient and expeditious way to apply paint is often achieved by utilizing a paint or any other coating specific type sprayer. While expeditious the use of paint sprayers often lead to overspray and the painting of undesired surfaces. To address this problem, several paint shields have been developed over the years.

The existing paint shields on the market (with one exception, the paint shield for roof structures, U.S. Pat. No. 7,854,212, of my design), requires a person to hold the shield through the means of a handle or other means in one hand and the spray gun on the other, or having a second individual holding the shield. A waste of time and valuable labor as well as unnecessary strain on the workers.

The hand held paint shields due to limitations on length, forces that the spraying of the paint on the desired surface, be done on short bursts, preventing an even coat of paint to be applied to the desired surface. At times accidental over spray occurs due to overshooting of the hand held shield. Adding to the shortcoming of hand held paint shields is that the repeated spraying of paint onto the hand held shield causes paint build up on the shield surface, often causing contamination of the surfaces where paint is not to be applied.

The hand held shields have to be continuously repositioned, implying that the person holding it, have to move several times, in many instances having to climb up and down ladders, decreasing productivity and increasing the chances of injures from falls, as well as increasing the risk of long term injuries to workers due to repeated climbing of ladders. It is common for career painters to develop booth hips and knee injuries.

Due to the above described problems and shortcomings of the existing paint shields and the inefficient and wasteful use of masking films paper and tape, there is a need for a paint shield that is specifically designed to allow for the use of sprayers while diminishing the strain on workers, increasing productivity and improving the quality of the job and the performance of the paints used.

Furthermore, there is a need for a paint shield that protects large areas or an entire soffit/exterior wall, interface areas of a whole building, or entire wall, limiting the number of mistakes and overspray of undesired surfaces.

There is also a need for a paint shield that is self retained, freeing the worker to perform its tasks, without the need to handle awkward hand held shields or slow wasteful masking materials.

There is a need of a paint, stucco or other coats, shield, that once properly installed provides the desirade protection from overspray and that it can be remotely removed, and that it is reusable.

### BRIEF SUMMARY OF THE INVENTION

In view of the shortcomings in the art it would be advantageous to have a paint shield that easily and temporarily attaches to a soffit or wall structure while spray painting a home or building. A paint shield that is reusable and that it can be remotely removed, from a distance or in the case from the ground.

Accordingly the present invention refers to a paint shield that is reusable, temporarily attaches to a soffit, wall structure or the like, freeing the worker from the duty of holding an awkward shield. A paint shield that once placed, stays where is put and that it can be remotely removed from the ground.

One embodiment of the present inventions consist of a pad or sheet of cardboard plastic or any suitable material, in which the pad or shield itself is configured so on one of its longer edges, the shield is configured with a grove or opening. The said groove made on such a way as to provide an opening in which the lower “lip” of a “J” shaped soffit trim, can be fitted, providing a support for the shield.

Another embodiment of the present invention consists of a pad or shield per se, and an attaching portion that booth attaches to the shield in one edge and to the soffit on the other edge. The attaching pad having a cross section of a modified “H” shape or any other suitable shape to fulfill the desired function. The attaching part being made by extrusion or any other suitable method, being made of plastic or any material suited to the function.

Another embodiment of the present inventions consist of a pad or sheet of cardboard or plastic or any other suitable material, in which one of its longitudinal edges is of a small thickness allowing it to be inserted in between adjacent parts of a home or building in a manner that the interference or “grip” created by the adjacent surfaces on the attaching part of the shield holds the shield in place.

One embodiment of the invention the shield is fitted with hooks or any other grasping device that allows for a string or any other string like apparatus to be attached to it, on a way that a person familiar with the invention, when pulling on the said string are able to remove the shield from its placed position.

In another embodiment of the invention a combination of any of the above described embodiments can be incorporated in one shield.

Another embodiment of the present invention, that can be combined with any of the other embodiments, Incorporates a “secondary” shield, attached to the shield, on a different plane then the shield, overlapping the adjacent shield, that way providing protection against overspray in the area between shields.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be ascertained from the following description of the invention when read in conjunction with the accompanying drawings, in which:

FIG. 1. Is a perspective view of a building, having several painting shields assembly attached to the soffit structure of the building, according to one embodiment of the invention, showing the release line and a painter/journeyman applying paint to the surface of the building.

FIG. 2. Is a under-view of the soffit of a building where two soffit shields in one of the embodiment of the present invention, are attached to the J molding of the soffit structure.

FIG. 3. is a side view of one of the embodiments of the present invention, clipped to the J molding of the soffit structure.

FIG. 4. is a side view of one embodiment of the present invention showing the attachment grove, secondary shield and release hook.

FIG. 5. Is a three dimensional view of one embodiment of the presents invention, from an elevated point of view.

FIG. 6. Is a three dimensional view of one embodiment of the present invention, being looked at, from a lower elevation point of view, showing the auxiliary shield on the bottom left.

FIG. 7. is a side view of one embodiment of the present invention, indicating the direction of movement for the proper attachment of the present invention onto the edge of the J-molding of the soffit structure.

FIG. 8. Is an augmented side view of the present invention, indicating the direction of movement for the proper attachment of the present invention, unto the “J” molding, part of the soffit structure.

FIG. 9. Is a side view of one embodiment of the present invention, attached to the soffit structure.

FIG. 10. Is a shaded, tridimensional view of another embodiment of the present invention.

FIG. 11. Is a side view of another embodiment of the present invention.

FIG. 12. Is side view of an embodiment of the present invention, installed unto the soffit structure.

FIG. 13 Is a side view of another embodiment of the present invention.

FIG. 14 Is a side view of another embodiment of the present invention

FIG. 15 Is a side view of an embodiment of the present invention, installed unto the soffit structure.

### DETAILED DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive feature illustrated herein, and additional applications of the principles of the inventions as illustrated herein, which would occur to one skilled in the relevant art and having possession of this disclosure, are to be considered within the scope of the invention.

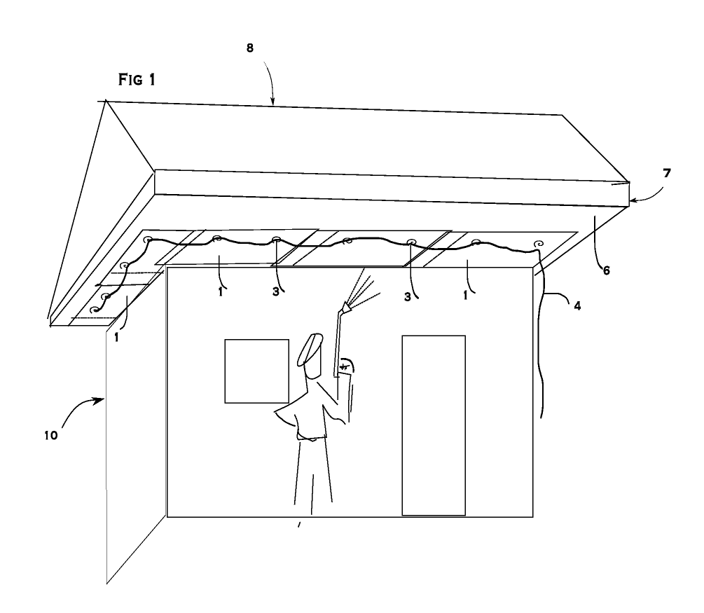

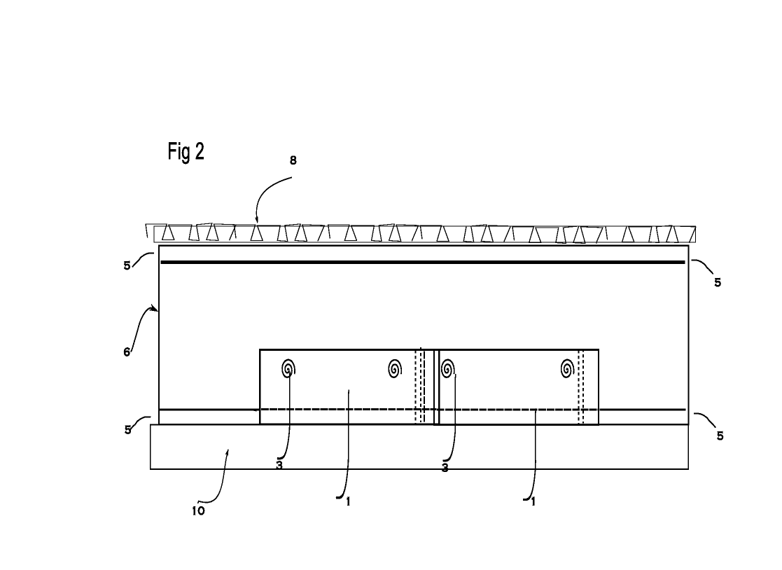

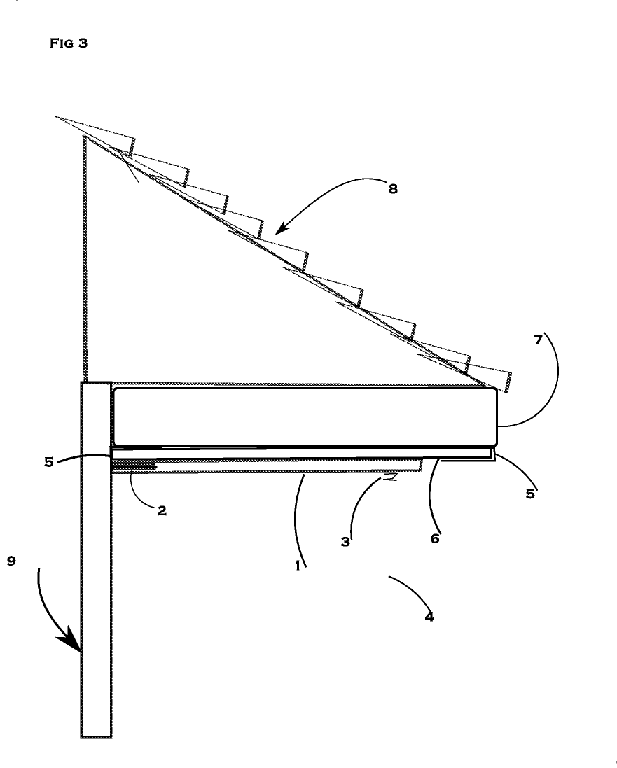

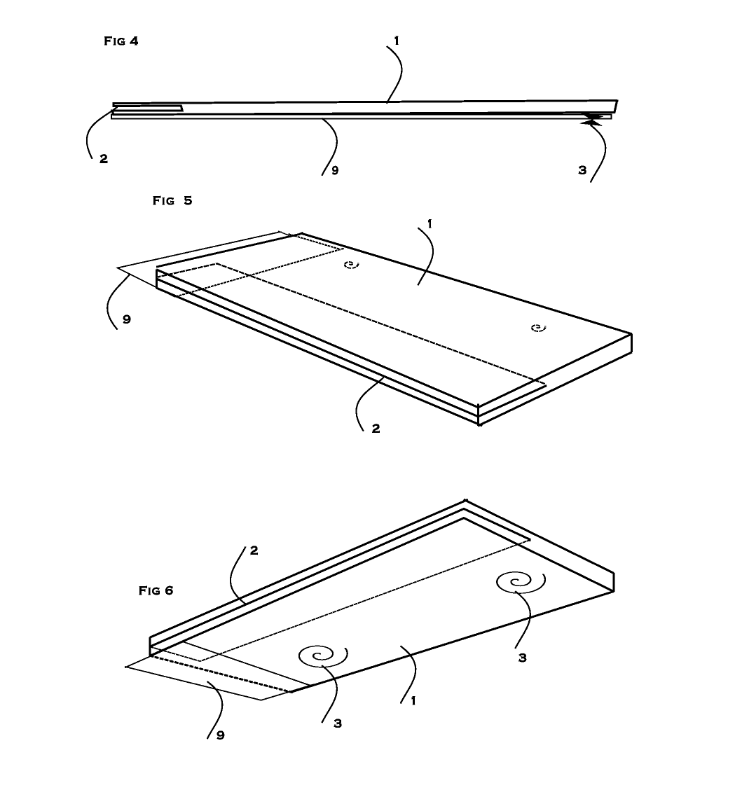

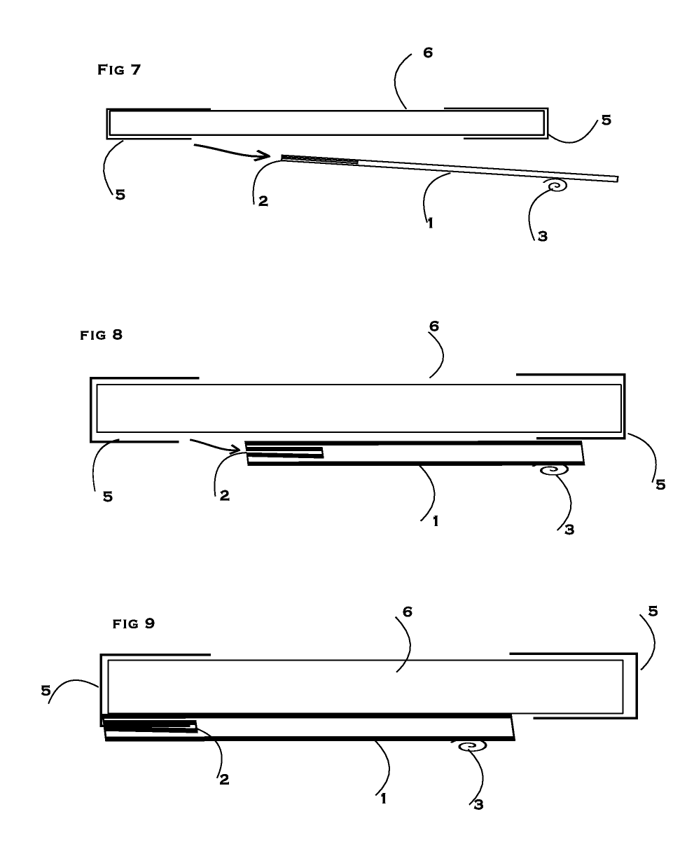

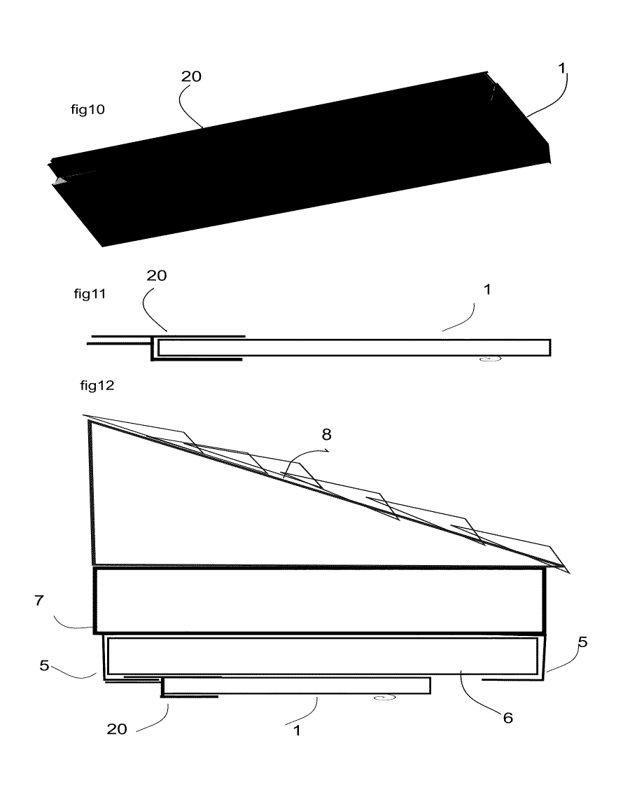

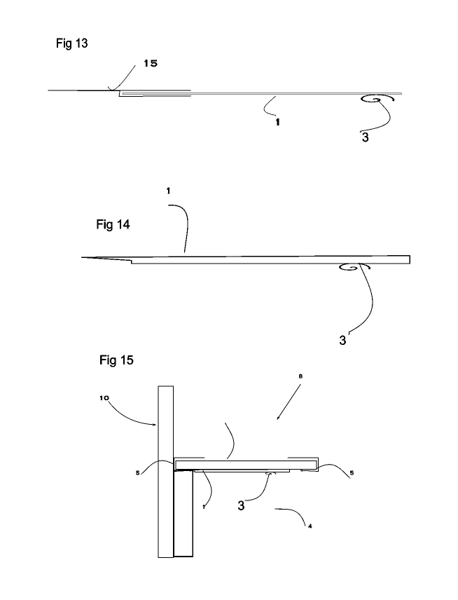

In reference to FIG. 1, there is illustrated paint shields 1, configured to temporarily attach to the soffit structure 6 of a building 10 providing protection against paint overspray and/or excess stucco of other coating material that might be desirable to apply to a exterior of a building, as is common practice for reasons of maintenance as well as esthetics.

In one embodiment the paint shield can attach to the edge of the “j” molding 5, of the soffit structure 6, in a self sustained way. The “j” molding 5 being an integral part of the soffit structure 6 and designed to hold the soffit structure 6 in place.

Aluminum, plastic, vinyl, steel or any other suitable material, soffits structures 6 are often used over existing wood soffits in older houses or building, to eliminate the need for such older wood trims to be painted or maintained. Further more, soffit structures made of man made materials that do not require or demand frequent painting or maintenance, are often used in newer buildings, as opposed to traditional materials that requires periodic painting or other forms of maintenance. As stated, soffits structures 6, are typically the undesired painting/stuccoed surfaces of a home or building. According to the present invention, the paint shield 1 is so configured as to provide a substantial shield, therefore preventing paint overspray of excessive stucco form contaminating the “j” molding 5, and the soffit structure 6.

In one embodiment, the paint shield 1, is configured to have a longitudinal groove 2, alongside one of its edges, as illustrated in FIGS. 4, 5 and 6 providing an opening in which the edge of the “j” molding 5 can be inserted into, creating an interference fit, as illustrated in FIGS. 3, 7 and 5, that way temporarily holding the paint shield 1, tightly against the soffit structure 6 and the “j” molding 5, protecting booth from paint overspray or excess stucco when of it application. This is a unitary configuration. FIG. 8 illustrates an augmented view of the paint shield 1 showing the groove 2, the “J” molding 5 and an directional arrow illustrating the desired location for the insertion of the edge of the “J” molding 5.

In another embodiment of the present invention, the shield 1, is attached to a longitudinal apparatus 20, with a cross sectional shape of a modified H figure, that once properly fit to one of the edges of the shield by means of attrition, interference or an adhesive material, stays in place and due to its cross sectional shape, provides for a attaching structure to which the shield 1 together with the apparatus 20 becomes temporarily attached to the “j” molding 5, providing the desired protection of the soffit structure 6 and “j” molding 5 from paint overspray or other coatings materials that might be applied to the building 10.

On occasion, the exterior of a building 10 is build on a certain way that the “J” molding 5, that supports the soffit structure 6, becomes obstructed by the exterior wall material, rendering it unviable for the use of booth, the unitarian configuration of the shield 1 with the groove 2 feature, as well as the two part configuration with the longitudinal apparatus 20, from FIGS. 10, 11 and 12. In those instances a third configuration for the paint shield 1, is necessary in order for a proper temporary attachment of the paint shield 1, as desired in order to provide a barrier to paint spray an other excessive coatings. To address the need of a self sustaining paint shield 1 in situations in which the “j” molding 5 is obstructed by the exterior nature of the house or building 10 other embodiments for the paint shield 1 is necessary and here explained. FIG. 7, illustrates one such embodiment in which a longitudinal apparatus 15, is attached to the paint shield 1, longitudinally alongside one of its edges through a tight interference fit or/and adhesive means. Such apparatus 15, having a modified cross sectional shape of the letter h in the lower case shape 15, providing in one of its side for an longitudinal opening in which the edge of the paint shield 1 is received, and a single blade like configuration longitudinally placed on the opposite side of the opening for the shield 1. Another embodiment of the present invention to be used on instances in which the “J” molding of the soffit structure 6, has become obstructed by different construction methods, is a unitarian construction in which one of the edges of the shield 1 is modified as to make it thiner and stiffer, that way allowing for its insertion longitudinally in the small space in between the soffit structure 6, and the exterior wall of the building 10, as illustrated in FIG. 15.

All the embodiments above disclosed described and illustrated on the drawings may benefit from a secondary shield 9, permanently attached to the primary shield 1. Such secondary shield 9, readily visible on FIG. 5 and FIG. 6, providing added protection for the soffit structure 6, by creating a barrier to paint spray and other coatings, over the space where the primary paint shields 1 abut each other. With this arrangement of a secondary shield 9 illustrated in FIGS. 5 and FIGS. 6, multiple paint shields can be attached to the soffit structure 6, along an entire length of a building, or a whole building if desired. The self attached paint shields stays in place allowing for the application of multiple coats, desired, required, being removed at the completion of the job by the method described bellow.

All the embodiments above disclosed described and illustrated on the drawings benefit as well from the hooks 3 that provide a temporary anchoring place for the release line 4, which is used for the remote retrieval of the paint shields 1 in all its configurations and embodiments. The benefits of the remote release of the paint shields from afar, without the need to climb ladders yet another time to remove what would be traditional masking is not small. The reduction in the number of climbs and ladder moves has the potential of reducing the number of booth long and short term injuries as well as greatly increasing productivity.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modification, equivalents, and alternatives falling within the spirit and scope of the invention.

What is claimed:

1. A self retained shield for protecting soffits, walls, or other structures of a building from accidental contamination by paint, stucco or other coating materials unto areas that are not intended to receive them. The shield comprising of a cardboard pad, plastic pad, or any other suitable material for the making of such a shield.

2. The paint shield of claim 1 wherein the attachment part of the shield is configured to be self retained to the soffit structure of a house or building, or any other structure to which the protection from contamination might be desired, and a suitable structure for the attachment of the self retaining shield with an interference type of fit is possible.

3. The shield of claim 1 in which a longitudinal groove alongside one of its edges allows for the insertion of the edge of the “J” molding of the soffit structure or any other suitable fixture of the structure to be shielded onto the grove, creating an interference type of fit.

4. The shield of claim 1 where there are two elements to the shield, one comprising of a pad of cardboard, plastic or any other suitable material, and another element suitable to attach to the edge of the shielding pad in a longitudinal direction, and the edge of the “J” molding of the soffit structure, or any other suitable fixture of the structure to be shielded, that fits on it with an interference type of fit.

5. The shield of claim 1 where the longitudinal edge of the shield alongside at least one of its side is thinner, allowing for its insertion lengthwise, in the space between two adjacent structures or fixtures, shielding one of the structures or fixtures from contamination from paints stucco or other coatings that may be applied onto the adjacent structures.

6. The shield of claim 1 where the primary shielding element is fitted with a second, smaller, secondary shielding element that provides protection against contamination in the butting areas of adjacent shields, the secondary shield being in a different plane.

7. The shield of claim one where the shields are fitted with attaching hooks or any other attaching fixture that allows the attachment of a string, line, cord or similar item that allows for the removal of the shields by pulling on the string, cord or similar item.
